(19) United States
(12) Patent Application Publication
(10) Pub. No.: US 2008/0276292 A1
(43) Pub. Date: Nov. 6, 2008

(54) Releasing System, Releasing Method Of Internet Television And Internet Television Client

(75) Inventor: Lu Han, Shenzhen (CN)

Correspondence Address: HARNESS, DICKEY & PIERCE, P.L.C., P.O. BOX 828, BLOOMFIELD HILLS, MI, 48303, US

(73) Assignee: TENCENT TECHNOLOGY (SHENZHEN) COMPANY LIMITED

(21) Appl. No.: 12/139,689

(22) Filed: Jun. 16, 2008

Related U.S. Application Data
(63) Continuation of application No. PCT/CN2006/003437, filed on Dec. 15, 2006.

(30) Foreign Application Priority Data
Dec. 16, 2005 (CN) 200510134790.3

(51) Int. Cl. H04N 7/173

(52) U.S. Cl. 725/109

(57) ABSTRACT

A releasing system and releasing method of Internet TV, an Internet TV client. The system includes a program releasing unit for releasing programs of an Internet TV channel; a switching information recording unit for recording and monitoring switching information of a channel, and issuing an activating instruction to the channel program switching unit according to monitored information; a channel program switching unit for receiving the activating instruction, and switching program source of the corresponding channel at the program releasing unit according to switching information of the channel. When the current time reaches the pre-determined time, operations such as switching, startup or tuning in a channel can be automatically performed, thus the system is more convenient for operating and stable in operation.

### CROSS-REFERENCE TO RELATED APPLICATIONS

This application is a continuation of International Application No. PCT/CN2006/003437, filed Dec. 15, 2006. This application claims the benefit of Chinese Application No. 200510134790.3, filed Dec. 16, 2005. The disclosures of the above applications is are incorporated herein by reference.

### FIELD

The present disclosure relates to an internet television (Internet TV) technology and to a releasing system and releasing method of Internet TV, and an Internet TV client.

### BACKGROUND

The statements in this section merely provide background information related to the present disclosure and may not constitute prior art.

Peer to Peer (P2P) structure is a novel network structure in broadband networks. It is different from traditional Client-Server (CS) mode in that the P2P structure has no central server or the central server is insignificant. The P2P technique surpasses the traditional CS mode in that it makes full use of each user's resources such as storage space, CPU and bandwidth, but costs little in operation and maintenance.

In conventional Internet TV technology, the P2P technique is usually adopted to implement living broadcasts of streaming media, for example, using IPTV to living broadcast sports news over the Internet. Streaming media refers to transmitting a multimedia file over a network using streaming technology, and the streaming technology refers to uploading compressed data of continuous video and audio to a network server and users may watch and listen to the content of the video and audio data while downloading without waiting for downloading of the whole compressed file.

An Internet TV system may provide a plurality of channels, and each of the channels has a plurality of program sources for providing different programs. For example, “non-homing cinema” is a movie channel, in which cartoons are from one program source, while actions are from another program source.

FIG. 1 is a structure of a conventional Internet TV system which includes at least one Internet TV client 101, a program releasing unit 102 and at least one program providing unit 103.

Accordingly, the Internet TV client 101 is operable for, according to a user's manual instruction, submitting an Internet TV receiving request to the program releasing unit 102, or for receiving program data forwarded by the program releasing unit 102 and decrypting and presenting the program data to the user.

The program releasing unit 102 is operable for, according to a current program address of each channel, collecting and saving program data from one or more program providing unit 103, and, on receipt of the Internet TV receiving request from the Internet TV client 101, encrypting the program data and forwarding the encrypted program data.

The program providing unit 103 is operable for broadcasting the program stored in the program providing unit 103, and on receipt of a data collection request from the program releasing unit 102, sending the ongoing program data to the program releasing unit 102 via a path such as a cable TV line.

In addition, for an Internet TV system using the P2P technique, the Internet TV client 101 may also act as a program providing unit 103 which stores a program source.

In the above system, when the program source of a channel needs to be changed, an administrator may manually change the program address at the program releasing unit 102. Therefore, when different programs will be broadcasted in the same channel at different time, the administrator has to frequently change the system settings, thus increasing the unreliability in providing the programs and the operating cost of the Internet TV is high.

In addition, when a user watches a TV program on a network, he has to turn on the Internet TV client manually, and to search manually for a channel. If the user forgets the time and channel of a program, he may miss the program.

### SUMMARY

Various embodiments provide a system and a method for releasing Internet TV program, an Internet TV client, and the main technical schemes are described as follows.

A releasing system of Internet TV includes a program releasing unit for releasing programs of an Internet TV channel;

and the system further includes a switching information recording unit and a channel program switching unit, in which

the switching information recording unit is operable for recording and monitoring switching information of a channel, and issuing an activating instruction to the channel program switching unit according to monitored information;

the channel program switching unit is operable for receiving the activating instruction, and switching program source of the channel at the program releasing unit according to switching information of the channel.

A releasing method of Internet TV includes:

pre-setting and recording switching information of a channel;

issuing an activating instruction when determining that current time reaches the switching time of the recorded switching information of the channel;

acquiring the switching information of the channel according to the activating instruction, and switching the program source for the channel.

An Internet TV client includes: an Internet TV processing unit and a startup information recording unit, in which

the startup information recording unit is operable for recording and monitoring time-startup information set by a user, and issuing an activating instruction to the Internet TV processing unit according to monitored information;

the Internet TV processing unit is operable for receiving the activating instruction, acquiring the time-startup information corresponding to the activating instruction from the startup information recording unit, transmitting an Internet TV receiving request according to the time-startup information, and receiving and/or playing an Internet TV program.

A method adopted by an Internet TV client for starting the Internet TV client which includes an Internet TV processing unit and a startup information recording unit includes:

pre-setting and recording time-startup information;

issuing, by the startup information recording unit, an activating instruction to the Internet TV processing unit when determining that current time reaches the pre-determined time according to the recorded time-startup information;

obtaining, by the Internet TV processing unit from the startup information recording unit, the time-startup information corresponding to the activating instruction, and transmitting an Internet TV receiving request according to the time-startup information.

It can be seen from the above technical schemes that, according to the releasing system of Internet TV and the corresponding method, switching information of a channel is pre-set so that switching of the program source for the channel can automatically performed when the current time of the system reaches the switching time, thus fewer manual work is required and operating cost is reduced, and the system is more convenient for operating and is stable in operation.

Various embodiments also provide an Internet TV client and a method for startup the Internet TV client. Startup information is pre-set in the Internet TV client, and the client may start automatically according to the startup information and initiate an Internet TV receiving request. On the basis of the above client and method, a user can pre-determined time for accessing a channel so as not to miss a program, thereby the service quality perceived by the user is improved.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic illustrating a conventional structure of an Internet TV system.

FIG. 2 is a schematic illustrating a structure of the releasing system of Internet TV program in an embodiment.

FIG. 3 is a flowchart illustrating a releasing process of Internet TV program in an embodiment.

FIG. 4 is a schematic illustrating an Internet TV client in an embodiment.

FIG. 5 is a flowchart illustrating the startup process of an Internet TV client in an embodiment.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

Embodiments provide a releasing system of Internet TV which can automatically switch a program source for a channel according to pre-set information. Accordingly, a releasing method of Internet TV is also provided, which implements automatic switching of a program source in a releasing system of Internet TV, thus less manual operation is required and stability of the system is improved.

Embodiments also provide an Internet TV client which can automatically start and receive a pre-set channel, and thus reducing participation of a user. Accordingly, a method for startup an Internet TV client is also provided, in which with the Internet TV client can tune to a channel at a pre-determined time to acquire program data and presenting the program to a user, thus improving service quality perceived by the user.

FIG. 2 shows a structure of a releasing system of Internet TV in an embodiment which includes a channel switching setting unit 201, a switching information recording unit 202, a channel program switching unit 203, a program releasing unit 204, at least one Internet TV client 205 and at least one program providing unit 206. The switching information recording unit 202 includes: an information storage center 2021 and a monitoring module 2022.

The channel switching setting unit 201 is operable for setting switching information for a channel, and saving the information in the information storage center 2021 of the switching information recording unit 202.

The channel switching setting unit 201 can be implemented by various means, such as by an operable HTTP page, by an application program of a C/S structure in the client, and so on.

The information storage center 2021 is operable for storing switching information of a channel, operation log, etc., and may be embodied by a database. The switching information of a channel includes: an identity of the to-be-switched channel, an address of a current program source, an address of a new program source, time for the switching, mode for reporting, backup operation in case of a switching failure and so on.

The monitoring module 2022 is operable for automatically activated when the releasing system of Internet TV starts up, checking the records in the information storage center 2021, and issuing an activating instruction to the channel program switching unit 203 when judging that current time reaches the pre-determined time recorded in a record.

In most situations, the monitoring module 2022 will check the information storage center 2021 at a pre-determined time for saving system resources. For example, the monitoring module 2022 may divide time into several slices, and performs a check in each time slice.

The channel program switching unit 203 is operable for acquiring the record corresponding to the activating instruction from the information storage center 2021, switching a program source for the channel at the program releasing unit 204 according to the switching information of the channel in the record, and logging in a switch log.

The process of switching a program source is as follows.

1) the channel switching unit 203 determines a program providing unit 206 corresponding to the address of a current program source, and stops the program providing unit 206 broadcasting the current program source.

2) the channel program switching unit 203 determines a program providing unit 206 corresponding to the address of a new program source, and begins broadcasting the new program source saved in the program providing unit 206.

Here, the program providing units 206 corresponding to the new and current program sources may be one network server or client or two different network servers or clients. The channel program switching unit 203 and program providing unit 206 typically reside in the same network.

3) the channel program switching unit 203 informs the program releasing unit 204 of the address of the new program source and the channel identity, and instructs the program releasing unit 204 to change the settings of the channel, and the program releasing unit 204 sets the program address of the channel to accord with the address of the new program source based on the channel identity.

In the above process, when a switch failure occurs, the channel program switching unit 203 may perform the backup operation set in the switching information to process the error. If the switch is successful, the channel program switching unit 203 will instruct all the currently online Internet TV clients 205 to perform a program update. On receipt of the program update instruction, a channel TV client 205 which is receiving the program may re-submit a request for obtaining the updated program data to the program releasing unit 204.

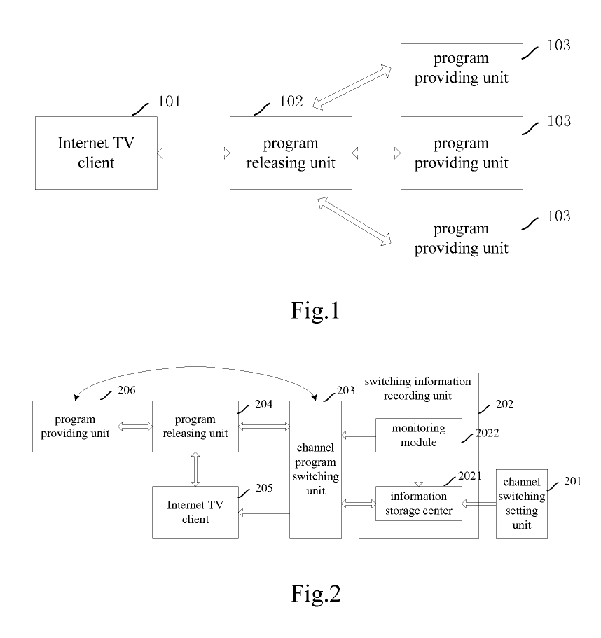

The attributes, such as constitution, functions, interconnections, of the program releasing unit 204, the Internet TV client 205 and the program providing unit 206 are the same as that in the prior art shown in FIG. 1, so the unnecessary detail is omitted herein.

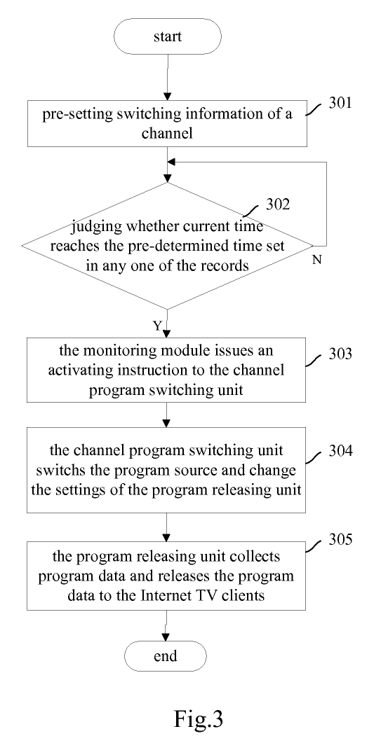

On the basis of the above system, the releasing method of Internet TV in the embodiment is illustrated in FIG. 3. By using the method, automatic switch among different program sources for a channel can be implemented.

In block 301, an administrator pre-sets switching information of a channel at the channel switching setting unit, and stores the switching information of the channel in the information storage center. And the switching information of the channel is a record in the information storage center.

In block 302, the monitoring module checks all the records stored in the information storage center, and determines whether the current time reaches the pre-determined time set in any one of the records. If the current time does not reach the pre-determined time set in any one of the records, perform step 302 again; if the current time reaches the pre-determined time set in one of the records, perform step 303.

In this block, the monitoring module may check the records at any pre-set time as required, for example, checking in real time. The monitoring module may divide time into several slices, and check periodically according to the time slices to save system resources. For example, one second is divided into 1000 time slices, and the monitoring module checks in every time slice (i.e., one millisecond).

In block 303, the monitoring module issues an activating instruction to the channel program switching unit, and the activating instruction carries a serial number of the record in which the pre-determined time matches the current time.

In block 304, after receiving the activating instruction, the channel program switching unit acquires the switching information of the channel from the information storage center according to the serial number of the record in the activating instruction, and instructs the program releasing unit to switch the program source of the channel.

In block 305: the program releasing unit collects program data from the address of the new program source according the settings after switching, and releases the program data to the Internet TV clients.

According to the system and method above, an administrator may pre-set the programs to be released, so that the programs can be automatically released without further manual operation when the current time reaches the release time. For example, on Friday, the administrator may set that releasing an NBA game of a regular season on Sunday. Thereafter, the administrator does not have to go to the office on Sunday to release the NBA game manually, and the system will automatically release the NBA program instead.

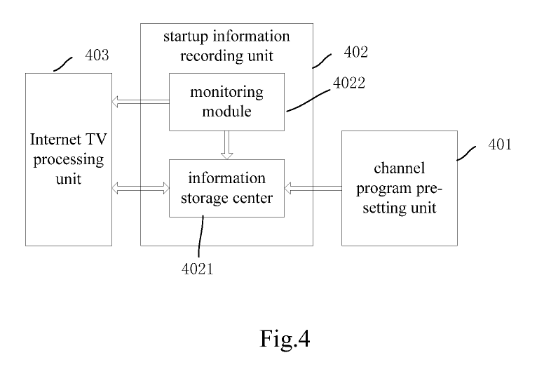

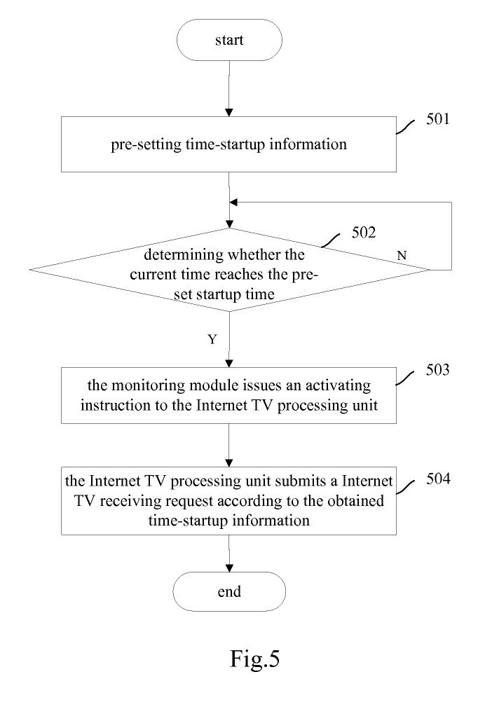

FIG. 4 is an Internet TV client in an embodiment, which includes: a channel program pre-setting unit 401, a startup information recording unit 402, an Internet TV processing unit 403. The startup information recording unit 402 includes: an information storage center 4021 and a monitoring module 4022.

The channel program pre-setting unit 401 is operable for pre-setting time-startup information, and storing the information in the information storage center 4021 of the startup information recording unit 402.

The channel program pre-setting unit 401 can be implemented by several means, such as by an operable HTTP page, by an application program of a C/S structure in the client, and etc.

The time-startup information may include time of startup, an identity of the channel and mode for reporting (e.g., prompt information or directly starting the Internet TV client and so on).

The monitor module 4022 is operable for checking all the records in the information storage center 4021, and issuing an activating instruction to the channel TV processing unit 403 when judging that the current time reaches the pre-determined time set in any one of the records.

The Internet TV processing unit 403 is operable for acquiring the record from the information storage center 4021 according to the activating instruction, and submitting an Internet TV receiving request for the program data of the channel according to the time-startup information. The channel Internet TV processing unit 403 is also operable for submitting an Internet TV receiving request, receiving and/or presenting an Internet TV program, and the functions are the same as that of the Internet TV client 101 in FIG. 1, so unnecessary details are omitted herein.

According to the client above, the process for time starting the client and automatically tuning to a channel is illustrated in FIG. 5, which includes the following steps:

In block 501, a user pre-sets time-startup information at the channel program pre-setting unit, and records the time-startup information in an information storage center of the channel program pre-setting unit.

In block 502, the monitoring module checks all the records saved in the information storage center, and determines whether the current time reaches the pre-determined time set in any of the records. If the current time does not reach the pre-determined time set in any of the records, perform step 502 again, and if the current time reaches the pre-determined time set in any of the records, perform step 503.

In block 503, the monitoring module issues an activating instruction to the Internet TV processing unit, and the activating instruction carries a serial number of the record whose pre-determined time matches the current time.

In block 504, after receiving the activating instruction, the Internet TV processing unit acquires the time-startup information from the information storage center according to the serial number in the activating instruction, and submits an Internet TV receiving request according to the obtained time-startup information.

It can be seen from the above embodiments that the releasing system of Internet TV, Internet TV client and method for starting an Internet TV client allow operations to be automatically performed, such as switching, starting up or tuning to a channel, thus fewer manual work is required and operation cost is reduced, and the system is more convenient for operating and is stable in operation, and service quality perceived by the user is improved.

The foregoing description is only the preferred embodiment and is not for use in limiting the protection scope thereof.

What is claimed is:

1. A releasing system of Internet TV, comprising a program releasing unit for releasing programs of an Internet TV channel;
a switching information recording unit for recording and monitoring switching information of a channel, and issuing an activating instruction to the channel program switching unit according to monitored information;
a channel program switching unit for receiving the activating instruction, and switching program source of the corresponding channel at the program releasing unit according to switching information of the channel.

2. The system of claim 1, wherein the switching information recording unit comprises: an information storage center and a monitor unit; wherein
the information storage center is operable for recording channel switching information;
the monitor module is operable for checking the records in the information storage center, and issuing an activating instruction to the channel program switching unit when judging that the current time reaches a pre-determined time in a record; and
the channel program switching unit is further operable for acquiring the record corresponding to the activating instruction from the information storage center.

3. The system of claim 2, further comprising a channel switch setting unit
for pre-setting switching information of a channel, and storing the switching information of the channel in the information storage center.

4. The system of claim 1, wherein the switching information of the channel comprises an address of the current program source and an address of a new program source of the channel; and
the system further comprises at least one program provide unit;
the channel program switching unit is operable for determining a program providing unit according to the address of the current program source, and stopping broadcasting the current program source; determining a program providing unit according to the address of the new program source, broadcasting the new program source stored in the program providing unit, and informing the program releasing unit of the address of the new program source; and
the program releasing unit is further operable for setting the address of the program in the channel as the address of the new program source.

5. The system of claim 2, wherein the switching information of the channel comprises an address of the current program source and an address of a new program source of the channel; and
the system further comprises at least one program provide unit;
the channel program switching unit is operable for determining a program providing unit according to the address of the current program source, and stopping broadcasting the current program source; determining a program providing unit according to the address of the new program source, broadcasting the new program source stored in the program providing unit, and informing the program releasing unit of the address of the new program source; and
the program releasing unit is further operable for setting the address of the program in the channel as the address of the new program source.

6. The system of claim 3, wherein the switching information of the channel comprises an address of the current program source and an address of a new program source of the channel; and
the system further comprises at least one program provide unit;
the channel program switching unit is operable for determining a program providing unit according to the address of the current program source, and stopping broadcasting the current program source; determining a program providing unit according to the address of the new program source, broadcasting the new program source stored in the program providing unit, and informing the program releasing unit of the address of the new program source; and
the program releasing unit is further operable for setting the address of the program in the channel as the address of the new program source.

7. The system of claim 1, further comprising: at least one Internet TV client; and
the channel program switching unit is further operable for issuing a program update instruction to the at least one Internet TV client.

8. The system of claim 2, further comprising: at least one Internet TV client; and
the channel program switching unit is further operable for issuing a program update instruction to the at least one Internet TV client.

9. The system of claim 3, further comprising: at least one Internet TV client; and
the channel program switching unit is further operable for issuing a program update instruction to the at least one Internet TV client.

10. A releasing method of Internet TV, comprising:
pre-setting and recording switching information of a channel;
issuing an activating instruction when determining that current time reaches the switching time of the recorded switching information of the channel;
acquiring the switching information of the channel according to the activating instruction, and switching the program source for the channel.

11. The method of claim 6, wherein the determining that current time reaches the switching time of the recorded switching information of the channel comprises: checking the records in specified time or checking the records in real-time to determine that current time reaches the switching time of the recorded switching information of the channel.

12. The method of claim 6, wherein the switching information of the channel comprises: an identity of the to-be-switched channel, an address of the current program source and an address of a new program source;
the switching the program source for the channel comprising:
determining the current program source according to the address of the current program source, and stopping broadcasting the current program source;
determining a new program source according to the address of the new program source, and broadcasting the new program source;
issuing a switching instruction carrying the identity of the to-be-switched channel and the address of the new program source, and setting the address of the program in the channel to accord with the address of the new program source according to the switching instruction.

13. The method of claim 10, wherein the switching information of the channel comprises: mode for reporting and a backup operation; and
that method further comprises: determining whether the switch of the program source is successful, and issuing a program update instruction if the switch of the program source is successful, or reporting the failure and performing the backup operation to handle the failure.

14. The method of claim 11, wherein the switching information of the channel comprises: mode for reporting and a backup operation; and
that method further comprises: determining whether the switch of the program source is successful, and issuing a program update instruction if the switch of the program source is successful, or reporting the failure and performing the backup operation to handle the failure.

15. The method of claim 12, wherein the switching information of the channel comprises: mode for reporting and a backup operation; and
that method further comprises: determining whether the switch of the program source is successful, and issuing a program update instruction if the switch of the program source is successful, or reporting the failure and performing the backup operation to handle the failure.

16. A Internet TV client, comprising: an Internet TV processing unit and a startup information recording unit; wherein
the startup information recording unit is operable for recording and monitoring time-startup information set by a user, and issuing an activating instruction to the Internet TV processing unit according to monitored information; and
the Internet TV processing unit is operable for receiving the activating instruction, acquiring the time-startup information corresponding to the activating instruction from the startup information recording unit, initiating an Internet TV receiving request according to the time-startup information, and receiving and/or playing an Internet TV program.

17. The Internet TV client of claim 10, wherein the startup information recording unit comprises:
an information storage center for recording time-startup information; and
a monitoring module for checking the records in the information storage center, and issuing an activating instruction to the Internet TV processing unit when judging that the current time reaches a pre-determined time set in the record; and
the Internet TV processing unit is operable for acquiring, from the information storage center, the record corresponding to the activating instruction.

18. The Internet TV client of claim 11, further comprising: a channel program pre-setting unit for pre-setting and storing time-startup information in the information storage center.

19. A method for starting the Internet TV client which includes an Internet TV processing unit and a startup information recording unit, comprising:
pre-setting and recording time-startup information;
issuing, by the startup information recording unit, an activating instruction to the Internet TV processing unit when determining that current time reaches the pre-determined time according to the recorded time-startup information;
obtaining, by the Internet TV processing unit from the startup information recording unit, the time-startup information corresponding to the activating instruction, and transmitting an Internet TV receiving request according to the time-startup information.

20. The method of claim 13, wherein the time-startup information comprises: time of startup, an identity of a channel and a prompt mode.
